(19) United States
(12) Patent Application Publication
(10) Pub. No.: US 2011/0182695 A1
(43) Pub. Date: Jul. 28, 2011

(54) ATTACHMENT MEANS

(76) Inventor: Christian BECK, Mauerkirchen (DE)

(21) Appl. No.: 12/732,408

(22) Filed: Mar. 26, 2010

(30) Foreign Application Priority Data
Jan. 26, 2010 (DE) 202010001325.9

(51) Int. Cl. F16B 35/06; F16B 23/00

(52) U.S. Cl. 411/399; 411/403

(57) ABSTRACT

An attachment mean joins together two-dimensional components in dry construction by means of a placement tool, in particular for fixing two-dimensional building materials onto a metallic substructure. The attachment means has a shaft on one end region of which a point and on the other end region of which a head are formed. A face side of the head facing away from the shaft is formed with a concave curve.

### CROSS-REFERENCE TO RELATED APPLICATIONS AND CLAIM TO PRIORITY

This application is related to utility model application number 202010001325.9, filed Jan. 26, 2010 in the Federal Republic of Germany, the disclosure of which is incorporated by reference and to which priority is claimed.

### FIELD OF THE INVENTION

The present invention relates to an attachment means for joining together two-dimensional components in dry construction by means of a placement tool, in particular for fixing two-dimensional building materials such as for example gypsum plasterboards or “DensGlas” boards onto a metallic substructure or a substructure made of wood, having a shaft on one end region of which a point and on the other end region of which a head are formed.

### BACKGROUND OF THE INVENTION

These types of attachment means are generally known in the prior art. Specifically in dry construction it is preferable due to the plurality of attachment means to be fastened to introduce the latter into the two-dimensional building material by means of nail placement tools such that a secure connection between the building material and the substructure is achieved.

A disadvantage with the attachment means used with nail placement tools is often the visual appearance. In particular, after driving in the placement nails either the entry points are damaged or the heads of the attachment means are clearly visible and mostly not flush with the surface of the building material to be attached so that the heads of the attachment means must subsequently be filled. However, the problem is evident here that the filler can mostly only be applied with considerable effort so that an even surface is formed on the building material. This is due to the fact, among other things, that the filler grips insufficiently onto the head of the attachment means mostly made of metal or plastic.

A further problem with the attachment means known in the prior art is that the surfaces of the two-dimensional components are often damaged when driving in the attachment means, and in particular covering papers provided on the surface of the two-dimensional components rip when driving in the attachment means, and this results in the necessity to fill the entry point of the attachment means over a large area.

### SUMMARY OF THE INVENTION

For the reasons specified above it is an object of the present invention to provide an attachment means for joining together two-dimensional components in dry construction by means of a placement tool which improves the visual appearance of the building material after the attachment means have been driven in.

This object is achieved according to the invention in that a face side of the head facing away from the shaft is formed with a concave curve.

In other words, by providing at least one concave curve in the head it is achieved that the filler which is applied when filling is held better by the head within the curve and accordingly grips better in the attachment region of the attachment means. In this way the formation of the most level possible surface by means of a filler is substantially simplified. It is therefore mostly possible to fill the entry points of the attachment means in just one working step. The individual entry points do not need to be treated repeatedly, and this is associated with a substantial saving of time.

The adherence of the filler to the head of the attachment means can be increased even further by the head having anchoring elements in the form of elevations and/or indentations in the region of the concave curve. The elevations and indentations can be applied, for example, by stamping into the face side of the head.

In one exemplary embodiment the elevations and/or indentations are arranged distributed like a spider's web over the concave curve of the face side of the head. The spider's web-type arrangement makes it possible for the filler to adhere homogeneously to the head of the attachment means.

In order to be able to draw the attachment means out of the two-dimensional building material or the metallic substructure again after being driven in, even at a later point in time, in one exemplary embodiment a notch is formed in the head for accommodating a tool for moving the attachment means within the components to be joined.

In order to prevent a covering paper provided on the two-dimensional component from ripping when driving in the attachment means, in one exemplary embodiment of the present invention the head is formed such that its diameter widens conically from its end facing towards the shaft to its end facing away from the shaft. By means of the conical widening of the head it is achieved that the covering paper pierced by the point of the attachment means in the region of the head when the attachment means is driven in is expanded more gently, and this counters ripping of the covering paper.

Particularly gentle expansion of the covering paper is achieved by the head having at least two sections with different, in particular increasing conicities.

In order to be able to draw the covering paper in even more cleanly when driving in the attachment means, in a further exemplary embodiment of the invention the head is provided on its end region facing towards the shaft with a circumferential punching or cutting edge. By means of this punching or cutting edge the hole made in the covering paper by the point is enlarged, in particular also punched or cut into the covering paper and then expanded on the covering paper by the conically widening round shape of the head, and drawn in cleanly beneath the face side facing towards the shaft in the region of the head without the paper ripping in the peripheral region of the hole.

In order to increase the pull-out values of the attachment means a fine thread, in particular a double fine thread, can be formed on the shaft of the attachment means, at least in some regions.

In a further exemplary embodiment provision is made to form a number of grooves on the shaft in addition to the fine thread which extend substantially parallel to the central axis of the shaft.

By providing grooves aligned axis-parallel to the shaft it is achieved that when driving the attachment means into the metallic substructure, according to the design and number of the grooves, small material projections remain in the region of joining to the substructure. These material projections provide the fine thread formed in the shaft with grip when twisting out the attachment means. When turning the attachment means within the sheet metal structure, the fine thread can cut thread turns in the material projection. Consequently, the attachment means does not turn in the sheet metal, but grips onto the material projection and can be twisted out of the joining region again.

Furthermore, the axis-parallel alignment of the groove makes it possible for the attachment means to be driveable into the combination of materials to be joined by an automatic nail gun substantially without any rotational movement.

With grooves arranged distributed evenly over the peripheral surface of the shaft it is further guaranteed that the attachment means can also be unscrewed evenly from the attachment region, for example by means of a cordless screwdriver. For this purpose the grooves should respectively extend over at least a partial section of the shaft.

### BRIEF DESCRIPTION OF THE DRAWINGS

Further advantageous embodiments can be taken from the sub-claims and from the drawings described in greater detail below. These show as follows:

FIG. 1: a perspective illustration of an attachment means according to the invention with a conically widening head;

FIG. 2: a perspective illustration of an attachment means with a concavely curved surface; and

FIG. 3: a partial illustration of an attachment means according to the invention with a conically curved face surface and a conically widening head.

### DETAILED DESCRIPTION OF THE PREFERRED EMBODIMENT(S)

FIG. 1 shows a perspective illustration of an attachment means 1 according to the invention having a conically widening head 2.

Here the attachment means 1 is designed in the form of a screw nail and serves to join together two-dimensional components in dry construction by means of a nail placement tool, in particular for fixing two-dimensional building material onto a metallic substructure. The attachment means 1 has a shaft 3 on one end region of which the conically widening head 2 is formed, and on the other end region of which a point 4 is provided. The head 2 has two sections 2a and 2b with different conicities. Here the conicities of the sections 2a and 2b differ in that the diameter of the head 2 increases more greatly from its end facing towards the shaft 3 to its end facing away from the shaft 3 in section 2b than in the upstream section 2a. In other words, the conicity chosen in section 2b is greater than in section 2a.

On a face side 5 of the head 2 facing towards the shaft 3, in this exemplary embodiment a circumferential punching or cutting edge 6 is formed. The punching or cutting edge 6 serves to enlarge the hole punched by the point 4 when driving the screw nail 1 into the components to be joined in a covering paper provided on the two-dimensional building material. The covering paper is then gently expanded by the conicity of the head 2 and drawn cleanly below the face side 5 facing towards the shaft 3 in the region of the head 2 without the covering paper ripping in the peripheral region of the hole. In other words, the effect of the conicity is that by means of the delayed increase in diameter it is made possible for the covering paper to yield in a certain manner, and this effectively counters ripping of the covering paper precisely in the visible attachment region.

The transition between the shaft 3 and the cutting edge 6 is initially formed angularly in order to guarantee reliable punching and so an enlargement of the hole in the covering paper.

In order to increase the pull-out values of the attachment means 1a fine thread 7 in the form of a double fine thread is formed on its shaft 3. Furthermore, the shaft is provided with a number of longitudinal grooves 8 which are arranged evenly distributed over the periphery. The grooves 8 extend substantially parallel to the central axis of the shaft 3.

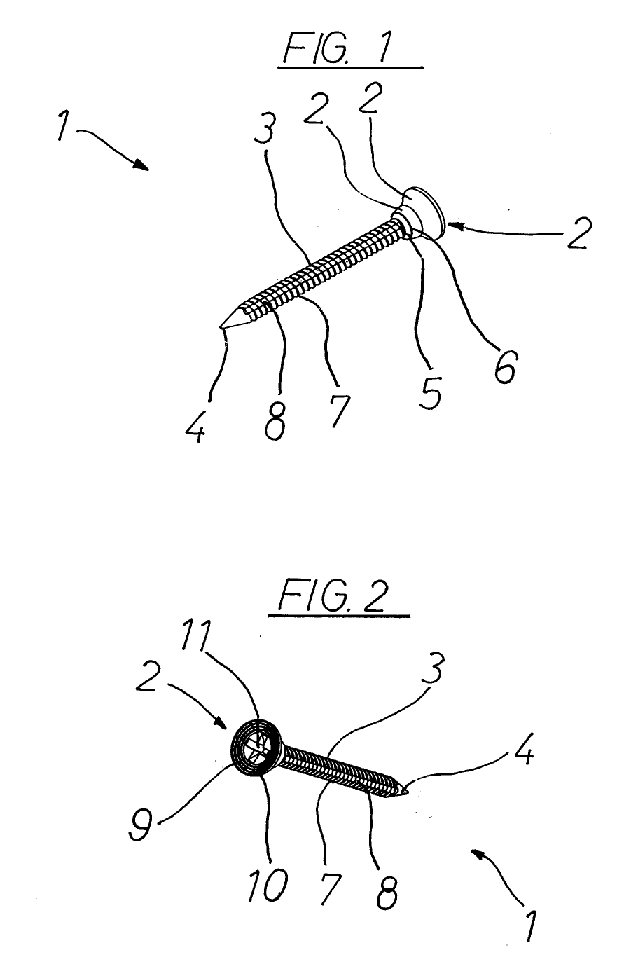

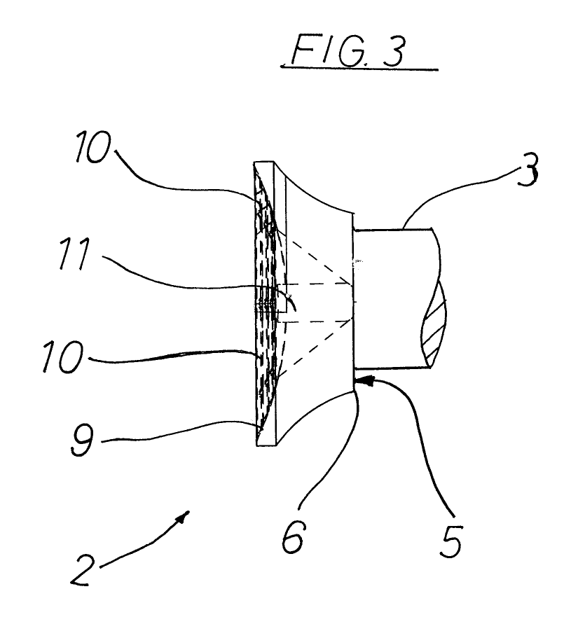

FIG. 2 shows a perspective illustration of an attachment means according to FIG. 1, of which the face side 9 facing away from the shaft 3 is formed with a consistent concave curve (see also FIG. 3). As can be seen particularly well in FIG. 3, by providing a concavely curved face side 9 and the conical design of the head 2 a shape is produced which is reminiscent of a trumpet shape. By means of the concave curve of the face side of the head 2 facing away from the shaft 3 it is achieved that filler to be applied to the head 2 after introducing the attachment means 1 into the components to be joined together in order to cover the attachment point is held better by the head 2, that is to say in the curve. The concave curve ensures here that the filler grips accordingly better onto the head 2. In this way the formation of the most level possible surface of the two-dimensional building material to be fixed by filling is substantially simplified. The entry points or the head of the attachment means 1 can mostly be filled in just one working step. The individual entry points of the attachment means 1 do not have to be treated repeatedly, as is often necessary elsewhere, and this is associated with a substantial saving of time.

In this exemplary embodiment the adherence of the filler to the head 2 of the attachment means 1 is further improved by providing anchoring elements 10 on the face side 9. Here the anchoring elements 10 are in the form of elevations 10 arranged evenly distributed like a spider's web. By means of the spider's web-type even distribution of the elevations 10 introduced into the face side 9 of the head 2, for example by punching, the filler can also adhere homogeneously to the head 2 of the attachment means 1.

Finally, a notch 11 is formed in the head 2 in the region of the central axis of the shaft 3 in order to be able to insert a tool into the latter which makes it possible to move the attachment means 1 within the components to be joined together after fitting. The notch 11 is square in form here so that bits with a square cross-section can grip well in the latter. Of course any form known from the prior art, such as for example a cross, a star or a hexagon shape, or also just a simple slot is conceivable in order to achieve this objective. The notch 11 can be formed to match any outer contour of the material to be pulled out.

In a further exemplary embodiment (not shown) a number of curves with different degrees of curvature are formed in the face side 9 so that a dimpled surface is produced.

In conclusion, it is established that the person skilled in the art recognises that the provision of a head with a conically widening diameter, even without providing at least one concavely curved face side of the head fulfils the object set at the start, as does the provision of an attachment means with a concavely curved face side of the head without a diameter of the head widening from its end facing towards the shaft to its end facing away from the shaft. Therefore, both aspects respectively independently achieve the object set at the start, a combination of both aspects, however, leading to an even better result.

I claim:

1. An attachment means (1) for joining together two-dimensional components in dry construction by means of a placement tool, in particular for fixing two-dimensional building materials onto a metallic substructure, the attachment means (1) having a shaft (3) on one end region of which a point (4) and on the other end region of which a head (2) is formed, characterised in that a face side (9) of the head (2) facing away from the shaft (3) is formed with a concave curve.

2. The attachment means (1) according to claim 1, characterised in that the head (2) has anchoring elements (10) in the form of elevations and/or indentations in the region of the at least one concave curve.

3. The attachment means (1) according to claim 2, characterised in that the elevations and/or indentations (10) are arranged distributed like a spider's web over the concave curve of the face side (9) of the head (2).

4. The attachment means (1) according to claim 1, characterised in that a notch (11) is formed in the head (2) for accommodating a tool for moving the attachment means (1) within the components to be joined.

5. The attachment means (1) according to claim 1, characterised in that the diameter of the head (2) widens conically from its end facing towards the shaft (3) to its end facing away from the shaft (3).

6. The attachment means (1) according to claim 1, characterised in that the head (2) has at least two sections (2a, 2b) with different conicities.

7. The attachment means (1) according to claim 1, characterised in that the head (2) has on its end region facing towards the shaft (3) a circumferential punching or cutting edge (6).

8. The attachment means (1) according to claim 1, characterised in that in order to increase the pull-out values of the attachment means a fine thread (7) is formed on the shaft (3), at least in some regions.

9. The attachment means (1) according to claim 1, characterised in that a number of grooves (8) are provided on the shaft (3) which extend substantially parallel to the central axis of the shaft (3).

10. The attachment means (1) according to claim 9, characterised in that the grooves (8) are arranged evenly distributed over the peripheral surface of the shaft (3) and extend respectively over at least a partial section of the shaft (3).

11. An attachment means (1) for joining together two-dimensional components in dry construction, in particular for fixing two-dimensional building materials onto a metallic substructure, having a shaft (3) on one end region of which a point (4) and on the other end region of which a head (2) is formed, characterised in that a diameter of the head (2) widens conically from its end facing towards the shaft (3) to its end facing away from the shaft (3).

12. The attachment means (1) according to claim 11, characterised in that the head (2) has at least two sections (2a, 2b) with different conicities.

13. The attachment means (1) according to claim 11, characterised in that the head (2) has on its end region facing towards the shaft (3) a circumferential punching or cutting edge (6).

14. The attachment means (1) according to claim 11, characterised in that a notch (11) is formed in the head (2) for accommodating a tool for moving the attachment means (1) within the components to be joined.

15. The attachment means (1) according to claim 11, characterised in that in order to increase the pull-out values of the attachment means (1) a fine thread (7) is formed on the shaft (3), at least in some regions.

16. The attachment means (1) according to claim 11, characterised in that a number of groves (8) are provided on the shaft (3) which extend substantially parallel to the central axis of the shaft (3).

17. The attachment means (1) according to claim 11, characterised in that the grooves (8) are arranged evenly distributed over the peripheral surface of the shaft (3) and extend respectively over at least a partial section of the shaft (3).
